(19) United States
(12) Patent Application Publication
(10) Pub. No.: US 2010/0270286 A1
(43) Pub. Date: Oct. 28, 2010

(54) ELECTRIC ROASTING PLATE

(75) Inventor: Chunyu WU, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/766,048

(22) Filed: Apr. 23, 2010

(30) Foreign Application Priority Data
Apr. 23, 2009 (CN) 200920137959.4

(51) Int. Cl. H05B 3/68

(52) U.S. Cl. 219/443.1

(57) ABSTRACT

The present invention relates to an electric roasting plate which comprises a roasting board, a heating coil laminated together with said roasting board. The shape and size of the heating area of the heating coil matches with the grilling area of the roasting board, so as to grill food well and to eliminate the possibility of distortion of the roasting board, and to lengthen the service life of the heating coil. It overcomes the shortages of the uneven temperature of the roasting board of the quadrate or other non round electric roasting plates and the short service life of the conventional heating coil.

### FIELD OF THE INVENTION

The present invention relates to a cooking apparatus, especially relates to a cooking apparatus which applies electric energy to grill food.

### BACKGROUND OF THE INVENTION

The conventional electric roasting plate as showed in FIG. 1, the back surface of the central part of the accidented grilling area of roasting board 1′ is laminated with the heating coil 2′. Generally, the roasting board 1′ is quadrate or other non round shapes, however, the heating coil 2′ is round. So the heating coil 2′ can only directly heat the round area of the center of the grilling area of roasting board 1′ which is above the heating coil 2′, the remaining grilling area of roasting board 1′ has to rely on the heat conduction to raise its temperature, so the temperature will be relatively low. The heating area is concentrated on the center of the grilling area of roasting board 1′, so the grilled food will not be heated evenly, the doneness of the food will not be even. In such a roasting plate, the round area of the central part of the roasting board 1′ will easily warps to distortion because of the uneven heating, further, because the heat is concentrated on the heating coil 2′, so the temperature will be relatively high, the service life of the heating coil 2′ will be short.

### SUMMARY OF THE INVENTION

The objective of the present invention is to provide an electric roasting plate, its roasting board is quadrate or other non round shapes, but the temperature of the roasting plate is even and the service life of the heating coil is relatively long.

The technical solution applied by the present invention is: an electric roasting plate, comprising a roasting board and a heating coil which are laminated together, characterizes in that the shape and size of the heating area of the heating coil matches with the grilling area of the roasting board.

The shape of the heating area of said heating coil is rectangle or oval or polygon.

The electric heating wires of the heating area of said heating coil are arranged uniformly.

The electric roasting plate of the present invention is by improving the shape and size of the heating area of the heating coil, makes the heating coil match with the grilling area of the roasting board, so the food will be grilled well, the doneness of the food will be even, and it will eliminate the possibility of the distortion of the roasting board, and it will lengthen the service life of the heating coil. The shape of the heating area of the heating coil is rectangle or oval or polygon, because the perimeters of such shapes are respectively longer than the perimeter of the round shape with the same size, so the distribution density of the electric heating wires in the heating area of the heating coil of such shapes are respectively lower than that of the round heating area when the electric power is the same (the length of the electric heating wire is the same), the temperature of the heating coil of such shapes is relatively low, so the service life of the will be lengthened. The shape of the heating area of the heating coil is rectangle or oval or polygon, so the heating will be more even when applied in different shapes of the grilling area of various kinds of roasting plates, so more different grilling area shapes can be selected. The electric heating wires are arranged uniformly in the heating area of the heating coil, so the temperature of the grilling area of the roasting plate will be more even.

### BRIEF DESCRIPTION OF THE DRAWINGS

FIG. 1 is the structural view of the conventional electric roasting plate.

FIG. 2 is the structural view of an embodiment of the electric roasting plate of the present invention.

FIG. 3 is the unfolded structural view of the embodiment of FIG. 2.

FIG. 4 is the structural view of an upper roasting board of an electric grilling device which applies the electric roasting plate of the present invention.

FIG. 5 is the structural view of an upper heating coil of the electric grilling device as indicated in FIG. 4.

FIG. 6 is the unfolded structural view of an upper shell of the electric grilling device as indicated in FIG. 4.

FIG. 7 is the structural view of a lower roasting board of the electric grilling device as indicated in FIG. 4.

FIG. 8 is the structural view of a lower heating coil of the electric grilling device as indicated in FIG. 4.

FIG. 9 is the unfolded structural view of a lower shell of the electric grilling device as indicated in FIG. 4.

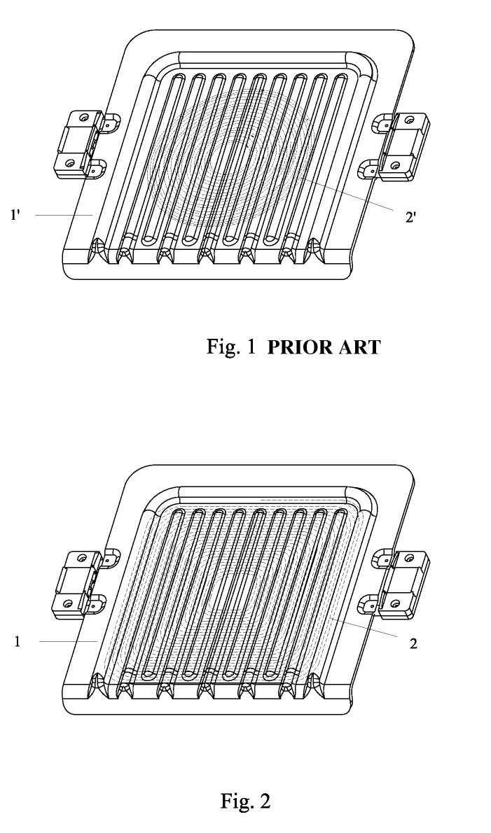

### DETAILED DESCRIPTION OF THE EMBODIMENTS

Firstly, Embodiment 1

The structure of an embodiment of the electric roasting plate of the present invention as showed in FIG. 2. The roasting board 1 and the heating coil 2 of said electric heating roasting plate are laminated together. The shape of the heating area of the heating coil 2 is quadrate, the size of the heating area of the heating coil 2 matches with the quadrate grilling area of roasting board 1.

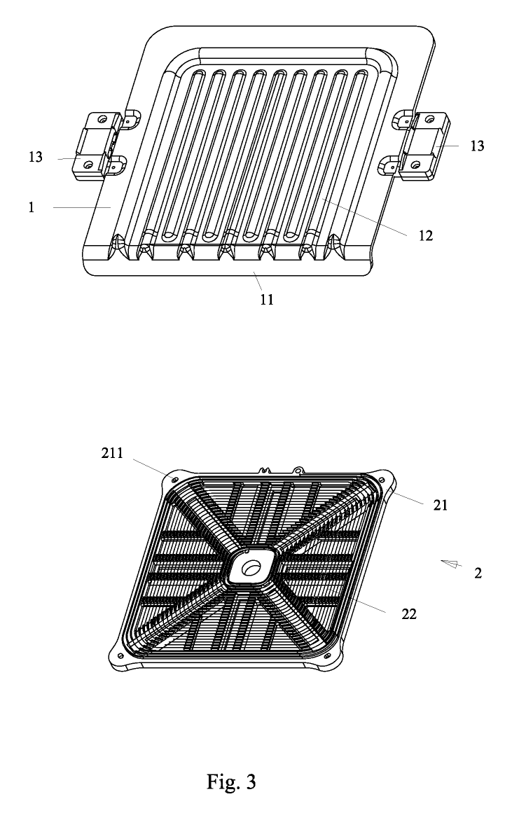

The unfolded structure of said electric roasting plate is showed in FIG. 3: the roasting board 1 is quadrate, its front end is an end surface 11 which bends downwardly. The roasting board 1 extends from the front end to the back end to form an accidented quadrate grilling area. The left and right sides of roasting board are respectively disposed with a handle 13.

The skeleton 21 of the heating coil 2 is quadrate, its four corners are respectively disposed with an installing hole 211, so as to be connected to the roasting board 1. The inside of the skeleton 21 has several hollowed-cuts, so multiple symmetrically disposed supporting strips are formed. Those supporting strips form a quadrate heating area. Each supporting strip has a wire slot, the electric heating wire 22 are uniformly distributed and warped in the wire slots of said supporting strips, so a quadrate heating surface is formed. The size of said heating surface matches with the quadrate grilling area 12 of roasting board 1. The wiring of the electric heating wire 22 in the quadrate heating coil 2 is relatively sparse, so the temperature of the heating coil 2 would not be too high, so it will reduce the possibility of the burning-out of the heating coil 2.

Certainly, the shape of the heating area of the heating coil 2 can also be rectangle or oval or polygon; so as to match with the rectangle or oval or polygon grilling area of roasting board 1, so the food of the roasting board 1 can be evenly heated, so the roasting board 1 is heated evenly and not likely to deform.

Secondly, Embodiment 2

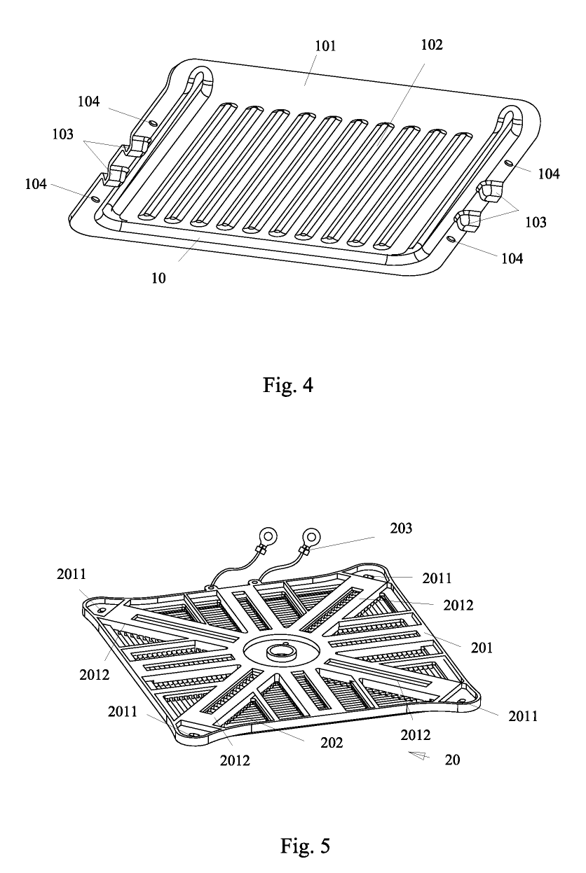

An unfolded structure of the electric grilling device which applies the electric roasting plate of the present invention, as showed in FIG. 4 to FIG. 9. Said electric grilling device comprises upper roasting board 10\ upper heating coil 20\ upper panel 301\ upper shell 30\ upper separating board 302\ lower roasting board 40\ lower heating coil 50\ lower separating board 601\ lower shell 60\ lower left hinge 602\ upper left 603\ lower right hinge 604 and upper right hinge 605 and other components, they cooperate with each other to respectively form upper roasting plate\ upper shell body which supports the upper roasting plate\ lower roasting plate\ lower shell body which supports the lower roasting plate\ hinge unit which connects the upper shell body and the lower shell body.

Please refer to FIG. 4: the upper roasting board 10 is rectangle, its front end is an end surface 101 which bends upwardly. The upper roasting board 10 extends from the front end to the back end to form an accidented rectangle grilling area 102. The left and right sides of the upper roasting board 10 respectively disposed with two retaining bosses 103 which project downwardly and two installing holes 104.

Please refer to FIG. 5: the skeleton 201 of the upper heating coil 20 is rectangle, its four corners are respectively disposed with an installing hole 2011. The inside of the skeleton 201 has several hollowed-cuts, so multiple symmetrically arranged supporting strips 2012 are formed. Those supporting strips 2012 form a rectangle heating area. Each supporting strip has a wire slot, the electric heating wires 202 are uniformly distributed and warped in the wire slots of those supporting strips 2012, so a rectangle heating surface is formed. The size of said heating surface matches with the rectangle grilling area 102 of upper roasting board 10. The two terminals 203 of electric heating wire 202 are led out.

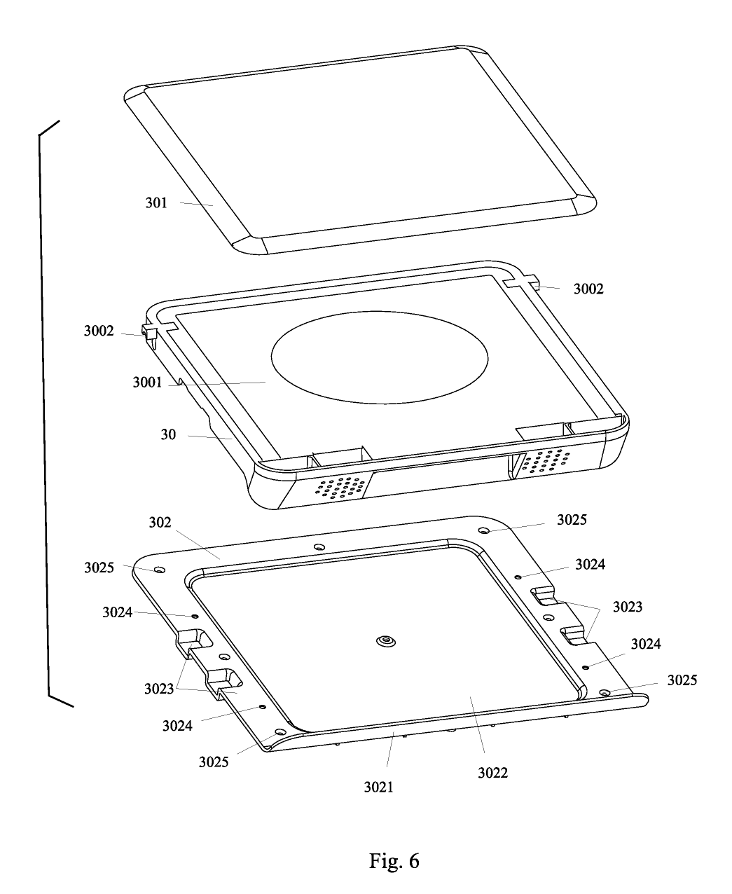

Please refer to FIG. 6: the upper shell 30 in the upper shell body of said electric grilling device is a rectangle box body which has a downward opening, a quadrate upper panel 301 covers the upper end surface 3001 of the upper shell 30. The back part of the left and right sides of upper shell 30 are respectively disposed with a lug 3002, so it will be convenient to install the corresponding upper hinge 603\605.

The upper separating board 302 of upper shell body is rectangle, its front end is the end surface 3021 which bends upwardly. The upper separating board 302 has a rectangle sunken area 3022 which corresponds to the upper heating coil 20. The left and right sides of the upper separating board 302 are respectively disposed with two retaining bosses 3023 which project downwardly and two installing holes 3024. The periphery of the upper separating board 302 has pluralities of via 3025.

The four screws respectively go through the installing holes 2011 of the four corners of the upper heating coil 20, so the upper heating coil 20 is fixed in the upper shell 30. The upper separating board 302 covers the upper heating coil 20 from below, so the upper heating coil 20 locates in the sunken area 3022 of the upper separating board 302. Multiple screws respectively go through the via 3025 on the periphery of the upper separating board 302, so the upper separating board 302 is fixed beneath the upper shell 30. The upper roasting board 10 fastens on the lower surface of the upper separating board 302, the end surface 101 of upper roasting board 10 contacts the end surface 3021 of the upper separating board 302, the retaining bosses 103 by the left and right sides of the upper roasting board 10 are clamped in the retaining bosses 3023 corresponding to the upper separating board 302. The four screws respectively go through the installing hole 104 of the upper roasting board 10 and the installing hole 3024 of the upper separating board 302, so the upper roasting board 10 is fixed on the upper shell 30. Thus, the upper roasting plate formed by the upper roasting plate 10 and the upper heating coil 20 is fixed on the upper shell body. So it will be convenient for the consumer take off the upper roasting board 10 for cleansing because of the protection of the upper separating board 302 to the heating coil 20.

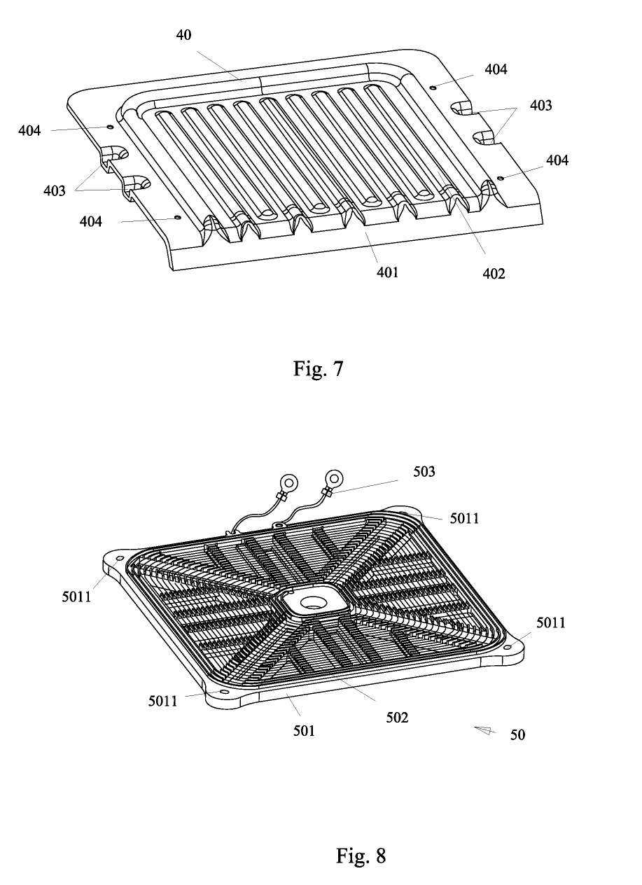

Please refer to FIG. 7: the lower roasting board 40 is rectangle, its front end is an end surface 401 which bends upwardly. The lower roasting board 40 extends from the front end to the back end to form an accidented rectangle grilling area 402. The left and right sides of the lower roasting board 40 respectively disposed with two retaining bosses 403 which project downwardly and two installing holes 404.

Please refer to FIG. 8: the skeleton 501 of the lower heating coil 50 is rectangle, its four corners are respectively disposed with an installing hole 5011. The inside of the skeleton 501 has several hollowed-cuts, so multiple symmetrically disposed supporting strips are formed. Those supporting strips form a rectangle heating area. Each supporting strip has a wire slot, the electric heating wire 502 uniformly disposed and warped in the wire slots of the supporting strips, so a rectangle heating surface is formed. The size of said heating surface matches with the rectangle grilling area 402 of the lower roasting board 40. The two terminals 503 of the electric heating wire 502 are led out.

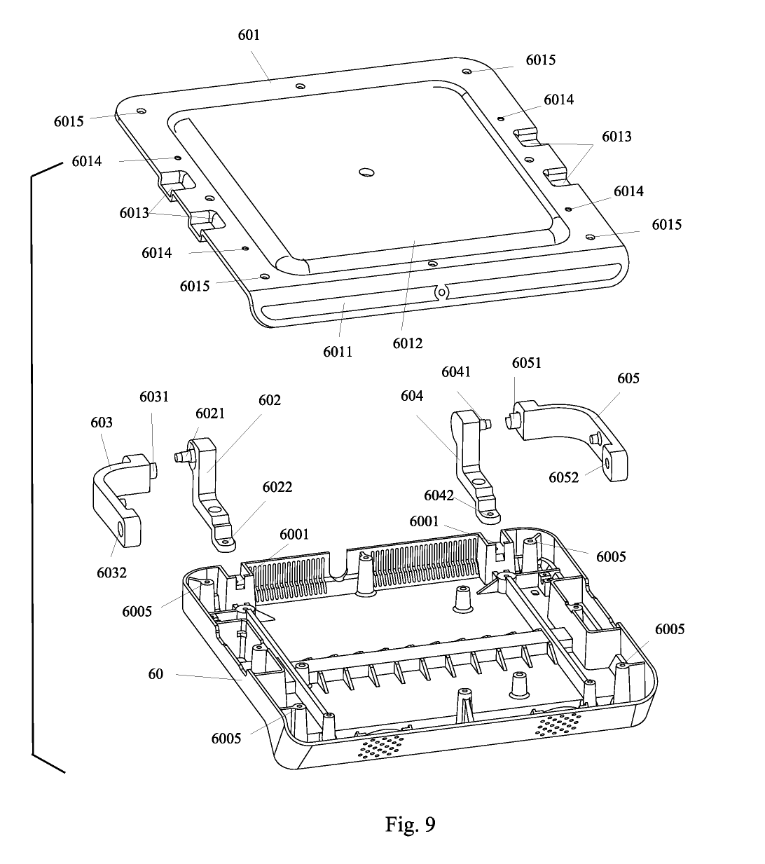

Please refer to FIG. 9: the lower shell 60 of the lower shell body of said electric grilling device is a rectangle box body which has an upward opening. The left and right sides of the back part of lower shell 60 respectively has a sunken part 6001, so as to install the corresponding lower hinge 602\604. The inside of the lower shell 60 is peripherally disposed with several projecting posts 6005, each of which has a screw hole on its top.

The lower separating board 601 of the lower shell body is rectangle, its front end is an end surface 6011 which bends downwardly. The lower separating board 601 has a rectangle top protruding area 6012 corresponding to the lower heating coil 50. The left and right sides of lower separating board 601 are respectively disposed with two retaining bosses 6013 which project downwardly and two installing holes 6014. The periphery of the lower separating board 601 has several via 6015.

The four screws respectively go through the installing holes 5011 of the four corners of lower heating coil 50, so the lower heating coil 50 is fixed inside the lower shell 60. The lower separating board 601 covers the lower heating coil 50 from above, so the lower heating coil 50 is located in the top protruding area 6012 of the lower separating board 601. Multiple screws respectively go through the via 6015 on the periphery of the lower separating board 601 and locked in the screw hole of the projecting post 6005 corresponding to the lower shell 60, so the lower separating board 601 is fixed upon the lower shell 60. The lower roasting board 40 fastens on the top surface of the lower separating board 601, the end surface 401 of lower roasting board 40 contacts the end surface 6011 of the lower separating board 601, the retaining bosses 403 by the left and right sides of the lower roasting board 40 are clamped with the retaining bosses 6013 corresponding to the lower separating board 601. The four screws respectively go through the installing holes 404 of the lower roasting board 40 and the installing holes 6014 of the lower separating board 601, so the lower roasting board 40 is fixed on the lower shell 60. Thereby, the lower roasting plate formed by the lower roasting board 40 and lower heating coil 50 is fixed upon the lower shell body. So it would be convenient for the consumer to take off the lower roasting board 40 for cleansing because of the protection of the lower separating board 601 to the lower heating coil 50.

The lower end 6022 of the lower left hinge 602 of the hinge unit is fixed in a sunken part 6001 by the left side of the lower shell 60, the transverse shaft on the top end of lower left hinge 602 is inserted into the shaft sleeve 6031 on the back end of the upper left hinge 603. The front end 6032 of the lower left hinge 603 is fixed on the lug 3002 by the left side of the upper shell 30. The lower end 604 of the lower right hinge 604 is fixed on the sunken part 6001 by the right side of the lower shell 60. The transverse shaft on the upper end of the lower right hinge 604 is inserted into the shaft sleeve 6051 on the back end of the upper right hinge 605. The front end 6052 of the upper right hinge 605 is fixed on the lug 3002 by the right side of the upper shell 30. The upper shell body rotates relative to the lower shell body by the hinge unit.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. An electric roasting plate, comprising a roasting board and a heating coil which are laminated together, characterizes in that the shape and size of the heating area of the heating coil matches with the grilling area of the roasting board.

2. The electric roasting plate according to claim 1, wherein the shape of the heating area of said heating coil is rectangle.

3. The electric roasting plate according to claim 1, wherein the shape of the heating area of said heating coil is oval.

4. The electric roasting plate according to claim 1, wherein the shape of the heating area of said heating coil is polygon.

5. The electric roasting plate according to claim 1, wherein the electric heating of said heating coil are arranged uniformly.
